(19) United States
(12) Patent Application Publication
(10) Pub. No.: US 2026/0340032 A1
(43) Pub. Date: Oct. 29, 2026

(54) VIDEO DISPLAY METHOD AND APPARATUS, AND COMPUTER DEVICE AND STORAGE MEDIUM

(71) Applicant: Beijing Zitiao Network Technology Co., Ltd., Beijing (CN)

(72) Inventors: Zonghui PENG, Beijing (CN); Jia SONG, Beijing (CN); Siyu LIU, Beijing (CN)

(21) Appl. No.: 19/103,798

(22) PCT Filed: Mar. 18, 2024
(86) PCT No.: PCT/CN2024/082090

§ 371 Date: Feb. 13, 2025

(30) Foreign Application Priority Data
Mar. 17, 2023 (CN) 202310274199.6

(51) Int. Cl. G06F 16/735; G06F 16/738; G06F 21/62

(52) U.S. Cl. CPC G06F 16/735; G06F 16/738; G06F 21/6218

(57) ABSTRACT

Provided in the present disclosure are a video display method, and a computer device and non-transitory a storage medium. The method includes: receiving search information, wherein the search information includes search intentions of a plurality of search dimensions; displaying a plurality of first videos corresponding to the search information and video preview information corresponding to the first videos on a search result page, where the plurality of first videos match the search intentions of the search dimensions; determining a plurality of second videos in response to a trigger operation for a target video among the plurality of first videos, where the second videos are determined based on a search dimension corresponding to the target video; and playing the target video, and in response to a switching operation for the target video, playing the second videos in a target order.

The present application claims the priority to the Chinese Patent Application No. 202310274199.6, which was filed on Mar. 17, 2023, the disclosure of which is incorporated herein by reference in its entirety as part of the present application.

### TECHNICAL FIELD

Embodiments of the present disclosure relate to a video display method, an apparatus, a computer device, and a storage medium.

### BACKGROUND

When a user consumes a displayed video by means of searching, whether multiple videos related to search information are displayed comprehensively in one interface or multiple videos are displayed one by one in full-screen display manner, the videos will be arranged and displayed in the same order, for example, the order of arrangement is determined according to the degree of association between each video and the search information.

In this case, no matter which way the user uses to view the videos, in the process of viewing the videos one by one, there will be a problem that contents of the viewed similar videos tend to be consistent and the relevance will be gradually weakened. The content that the videos can bring is not rich enough, and it cannot meet the actual viewing needs of users for the videos during searching.

### SUMMARY

Embodiments of the present disclosure at least provide a video display method, an apparatus, a computer device and a storage medium.

In a first aspect, embodiments of the present disclosure provides a video display method comprising, the method comprises: receiving search information, where the search information comprises search intentions of a plurality of search dimensions; displaying a plurality of first videos corresponding to the search information and video preview information corresponding to each of the first videos on a search result page, where the plurality of first videos match the search intentions of the search dimensions, and the video preview information of the first videos is used for representing the search dimensions corresponding to the first videos; determining a plurality of second videos in response to a trigger operation for a target video among the plurality of first videos, where the second videos are determined based on a search dimension corresponding to the target video; and playing the target video, and in response to a switching operation for the target video, playing the second videos in a target order.

In an optional implementation, the target order is dynamically determined by: obtaining first consumption data obtained with authorization of a user for playing a current second video and obtaining second consumption data obtained with authorization of the user for a historical second video played on a full-screen play page before the current second video, in a process of playing the current second video on the full-screen play page; and determining a next video to be played on the full-screen play page from a plurality of candidate videos based on trigger browsing behaviors for each of the first videos on the search result page and the first consumption data obtained with authorization of the user as well as the second consumption data obtained with authorization of the user.

In an optional implementation, the determining the next video to be played on the full-screen play page from the plurality of candidate videos based on the trigger browsing behaviors for each of first videos on the search result page and the first consumption data obtained with authorization of the user as well as the second consumption data obtained with authorization of the user, comprises: determining a target search dimension from a plurality of search dimensions corresponding to the first videos based on the trigger browsing behaviors; and determining first video features corresponding to each of the second videos played on the full-screen play page based on the first consumption data obtained with authorization of the user and the second consumption data obtained with authorization of the user; and determining the next video to be played on the full-screen play page from the plurality of candidate videos based on the first video features and second video features, where the second video features are indicated by the target search dimension.

In an optional implementation, the plurality of candidate videos are determined by: obtaining videos associated with the search information and/or the first video features corresponding to the current second video played on the full-screen play page, as the plurality of candidate videos.

In an optional implementation, the determining the next video to be played on the full-screen play page from the plurality of candidate videos based on the first video features and the second video features indicated by the target search dimension, comprises: sorting the plurality of candidate videos based on correlations between video features corresponding to each of the candidate videos and the first video features and/or the second video features; and selecting the next video to be played on the full-screen play page from the plurality of candidate videos based on a sorting result of the plurality of candidate videos.

In an optional implementation, the displaying the plurality of first videos on the search result page comprises: arranging and displaying each of the first videos in multi-column display mode on the search result page.

In an optional implementation, the video preview information corresponding to the first video is determined by: determining description information related to each of the search dimensions from the first videos; and integrating each of the description information determined from the first videos to obtain the video preview information corresponding to the first videos.

In an optional implementation, the description information related to each of the search dimensions is determined from the first videos by: determining text information associated with the first videos, where the text information comprises at least one of: introduction information of the first videos and text information identified from the first videos; performing semantic segmentation on the text information to obtain a plurality of candidate keywords; and determining, from the plurality of candidate keywords, at least one candidate keyword, corresponding semantic information of which matches the search dimensions, as description information related to the search dimensions.

In an optional implementation, the display order of the plurality of first videos is determined by: determining a dimension number of at least one search dimension represented by the video preview information of each of the first videos; and sorting the plurality of first videos with the dimension number determined for each of the first videos, and using a sorting result as the display order of the plurality of first videos.

In a second aspect, embodiments of the present disclosure further provides a video display apparatus, the apparatus including: a receiving module configured to receive search information, where the search information comprises search intentions of a plurality of search dimensions; a displaying module configured to display a plurality of first videos corresponding to the search information and video preview information corresponding to the first videos on a search result page, wherein the plurality of first videos match the search intentions of the search dimensions, and the video preview information of the first videos is used for representing the search dimensions corresponding to the first videos; a determining module configured to determine a plurality of second videos in response to a trigger operation for a target video among the plurality of first videos, where the second videos are determined based on a search dimension corresponding to the target video; and a playing module configured to play the target video and in response to a switching operation for the target video, to play the second videos in a target order

In an optional implementation, the video presentation apparatus further includes a processing module, and the target order is dynamically determined by the processing module by: obtaining first consumption data obtained with authorization of a user for playing a current second video and obtaining second consumption data obtained with authorization of the user for a historical second video played on a full-screen play page before the current second video, in a process of playing the current second video on the full-screen play page; and determining a next video to be played on the full-screen play page from a plurality of candidate videos based on trigger browsing behaviors for each of the first videos on the search result page and the first consumption data obtained with authorization of the user as well as the second consumption data obtained with authorization of the user.

In an optional implementation, when determining the next video to be played on the full-screen play page from the plurality of candidate videos based on the trigger browsing behaviors for each of first videos on the search result page and the first consumption data obtained with authorization of the user as well as the second consumption data obtained with authorization of the user, the processing module is configured to: determine a target search dimension from a plurality of search dimensions corresponding to the first videos based on the trigger browsing behaviors; and determine first video features corresponding to each of the second videos played on the full-screen play page based on the first consumption data obtained with authorization of the user and the second consumption data obtained with authorization of the user; and determine the next video to be played on the full-screen play page from the plurality of candidate videos based on the first video features and second video features, where the second video features are indicated by the target search dimension.

In an optional implementation, the processing module determines the plurality of candidate videos by: obtaining videos associated with the search information and/or the first video features corresponding to the current second video played on the full-screen play page, as the plurality of candidate videos.

In an optional implementation, when determining the next video to be played on the full-screen play page from the plurality of candidate videos based on the first video features and the second video features indicated by the target search dimension, the processing module is configured to: sort the plurality of candidate videos based on correlations between video features corresponding to each of the candidate videos and the first video features and/or the second video features; and selecting the next video to be played on the full-screen play page from the plurality of candidate videos based on a sorting result of the plurality of candidate videos.

In an optional implementation, when displaying the plurality of first videos on the search result page, the displaying module is configured to: arrange and display each of the first videos in multi-column display mode on the search result page.

In an optional implementation, the video preview information corresponding to the first video is determined by: determining description information related to each of the search dimensions from the first videos; and integrating each of the description information determined from the first videos to obtain the video preview information corresponding to the first videos.

In an optional implementation, the description information related to each of the search dimensions is determined from the first video by: determining text information associated with the first videos, wherein the text information comprises at least one of: introduction information of the first videos, and text information identified from the first videos; performing semantic segmentation on the text information to obtain a plurality of candidate keywords; and determining, from the plurality of candidate keywords, at least one candidate keyword, corresponding semantic information of which matches the search dimensions, as description information related to the search dimensions.

In an optional implementation, the display order of the plurality of first videos is determined by: determining a dimension number corresponding to at least one search dimension represented by the video preview information of each of the first videos; and sorting the plurality of first videos with the dimension number determined for each of the first videos, and using a sorting result as the display order of the plurality of first videos.

In a third aspect, an optional implementation of the present disclosure further provides a computer device, including a processor and a memory, where the memory stores machine-readable instructions executable by the processor, and the processor is configured to execute the machine-readable instructions stored in the memory, and when the machine-readable instructions are executed by the processor, when the machine-readable instructions are executed by the processor, the above first aspect is performed or steps in any possible embodiments of the first aspect are performed.

In a fourth aspect, an optional implementation of the present disclosure further provides a computer-readable storage medium, where a computer program is stored on the computer-readable storage medium, and when the computer program is run, the above first aspect is performed or steps in any possible embodiments of the first aspect are performed.

### BRIEF DESCRIPTION OF DRAWINGS

In order to illustrate the technical solutions of the embodiments of the present disclosure more clearly, the drawings that need to be used in the embodiments will be briefly described below. The drawings here are incorporated into the disclosure and constitute a part of the present disclosure. These drawings illustrate the embodiments in line with the present disclosure and are used to illustrate the technical solutions of the present disclosure. It should be understood that the following drawings only illustrate some embodiments of the present disclosure, and thus should not be regarded as limiting the scope. For those skilled in the art, other related drawings can be obtained according to these drawings without creative efforts.

FIG. 1 illustrates a flowchart of a video display method according to an embodiment of the present disclosure;

FIG. 2 illustrates a schematic diagram of displaying search results on a search result page according to an embodiment of the present disclosure;

FIG. 3 illustrates an example diagram of displaying video preview information according to an embodiment of the present disclosure;

FIG. 4 illustrates a schematic diagram of a full-screen play page according to an embodiment of the present disclosure;

FIG. 5 shows a schematic diagram of a video display apparatus according to an embodiment of the present disclosure; and

FIG. 6 illustrates a schematic diagram of a computer device according to an embodiment of the present disclosure.

### DETAILED DESCRIPTION

In order to make the objectives, technical solutions and advantages of the embodiments of the present disclosure clearer, the technical solutions in the embodiments of the present disclosure will be described clearly and completely in conjunction with the drawings in the embodiments of the present disclosure. Obviously, the described embodiments are only a part of the embodiments of the present disclosure, rather than all embodiments. Usually, the components of the embodiments of the present disclosure described and illustrated here can be arranged and designed in various different configurations. Therefore, the following detailed description of the embodiments of the present disclosure is not intended to limit the scope of the claimed present disclosure, but only represents selected embodiments of the present disclosure. Based on the embodiments of the present disclosure, all other embodiments obtained by those skilled in the art without creative efforts belong to the protection scope of the present disclosure.

It is found through research that when a user consumes a displayed video by means of searching, the displayed video obtained through searching will be arranged and displayed simply according to the correlation between the video and search information, which will lead to the problem that the contents of videos which are displayed in close proximity tends to be consistent, and the video content gradually deviates from the search intent after the user browses the videos continuously. Therefore, the information that can be displayed through the videos in this way is limited, and the actual viewing needs of the user for the videos during searching cannot be satisfied.

Based on the above research, the present disclosure provides a video display method, for received search information, the advantage that multiple videos can be displayed on a search result page can be utilized to display first videos matching search intentions corresponding to a plurality of search dimensions under the search information, and display the search dimensions corresponding to the first videos through video preview information during displaying, so that the user can select a video of interest for detailed viewing according to the video preview information.

For a video that continues to be played after the target video selected from the first videos, it is specifically determined according to the search dimension corresponding to the target video, that is, the selection of the target video by the user can reflect the needs of different search dimensions under the search information, and based on this, the video that continues to be displayed to the user is determined. In this way, videos that meet the needs of the user can be continuously pushed to the user without sorting according to the correlation between the videos and the search information, so that the displayed videos are richer and more likely to meet the actual viewing needs of the user for the videos.

The defects of the above-mentioned solution are the results obtained by the inventors after practice and careful research. Therefore, the discovery process of the above problems and the solutions proposed in the embodiments of the present disclosure for the above problems should be the contributions of the inventors to the present disclosure in the process of the present disclosure.

It should be noted that, similar reference numerals and letters in the following drawings represent similar items, therefore, once an item is defined in one drawing, it is not necessary to be further defined and explained in the subsequent drawings.

It can be understood that before using the technical solutions disclosed in various embodiments of the present disclosure, the type, scope of use, usage scenarios, etc. of the personal information involved in the present disclosure should be informed of users in an appropriate way according to relevant laws and regulations and be authorized by the users.

For example, in response to receiving an active request from an user, prompt information is sent to the user to explicitly prompt the user that the operations requested by the user will need to obtain and use the user's personal information. Therefore, the user can independently choose whether to provide personal information to software or hardware such as an electronic device, an application, a server or a storage medium that performs the operations of the technical solutions of the present disclosure according to the prompt information.

As an optional but non-limiting implementation, the way of sending the prompt information to the user in response to receiving the active request from the user may be, for example, a pop-up window, and the prompt information may be presented in text in the pop-up window. In addition, the pop-up window may also carry a selection control for the user to select “agree” or “disagree” to provide personal information to the electronic device.

It can be understood that the above process of notifying and obtaining the user's authorization is only illustrative, and does not limit the implementations of the present disclosure, and other methods that meet relevant laws and regulations may also be applied to the implementations of the present disclosure.

In order to facilitate the understanding of the embodiment, a video display method disclosed in the embodiments of the present disclosure will be described in detail first. The execution body of the video display method according to the embodiments of the present disclosure is generally a computer device with a certain computing capability, and the computer device includes, for example, a terminal device, a server or other processing devices. The terminal device may be a user equipment (User Equipment, UE), a mobile device, a user terminal, a terminal, a cellular phone, a cordless phone, a personal digital assistant (Personal Digital Assistant, PDA), a handheld device, a computing device, a vehicle-mounted device, a wearable device, etc. In some possible implementations, the video display method can be implemented by a processor calling computer-readable instructions stored in a memory.

The video display method according to the embodiments of the present disclosure will be described below. The video display method according to the embodiments of the present disclosure is mainly applied to search scenarios, and particularly relates to a scenario of displaying videos related to search information during searching, so it can be applied to application software such as a video play platform, video interactive software, etc.

In the video display method according to the embodiments of the present disclosure, a plurality of first videos can be displayed on a search result page, and second videos can also be displayed one by one on a full-screen play page. Here, the search result page is a display page of comprehensive results, which can be specifically used to carry and display the plurality of first videos, for example, displaying video preview information corresponding to the plurality of first videos. The full-screen play page is a page that can display the second videos individually, and compared with the search result page, the full-screen play page can display the complete content of the second videos. When displaying videos in the embodiments of the present disclosure, the respective advantages of the two video display pages are fully considered.

The search dimensions corresponding to the plurality of first videos are displayed through the search result page, and the content displayed is richer and more diverse, so that the user can easily determine the target video of interest through the arranged and displayed video preview information. Through the full-screen play page, the user can specifically view the videos to meet the consumption needs of the user for the videos. The two pages for displaying videos mentioned here will be specifically illustrated below, which will not be repeated here.

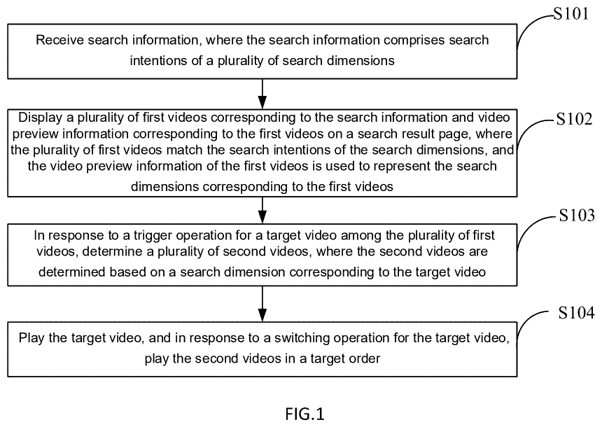

Referring to FIG. 1, it shows a flowchart of a video display method according to an embodiment of the present disclosure. The method includes steps S101-S104, where:
S101: receiving search information, where the search information includes search intentions of a plurality of search dimensions;
S102: displaying a plurality of first videos corresponding to the search information and video preview information corresponding to the first videos on a search result page, where the plurality of first videos match the search intentions of the search dimensions, and the video preview information of the first videos is used to represent search dimensions corresponding to the first videos;
S103: determining a plurality of second videos in response to a trigger operation for a target video among the plurality of first videos, where the second videos are determined based on a search dimension corresponding to the target video; and
S104: playing the target video, and in response to a switching operation for the target video playing the second videos in a target order.

The above S101-S104 will be described in detail below.

For the above S101, on the above-mentioned platforms such as the video play platform and the video interactive software and so on, the user can obtain information that the user wants to view by means of searching. In a specific implementation, when performing the search, the user enters search information in a search box and triggers a search button, and the user terminal can send a search request carrying the search information to a platform server, so that the platform server can further determine information to be displayed to the user according to the search request.

In a possible case, when the user performs the search through the search information, the search information may specifically include search intentions of a plurality of search dimensions. For example, when the user searches for a certain star “star A”, the search information may specifically be “the work of star A”, and such search information actually reflects the actual search intention of the user, that is, among the information associated with star A, such as encyclopedia information, identity information in a team to which the star belongs, etc., the information that the user actually wants to view is the work information. Therefore, under the search information, it may be determined that the search dimension includes a work dimension, which may be further subdivided into dimensions such as a song work, a variety show work, a film and television work, a clothing design work, and so on.

In some possible cases, the search information may not have a keyword indicating the search intention, for example, the search information is only “star A”. In this case, a plurality of related search dimensions may be predetermined as the search dimensions under the search information. For example, the type of the object actually indicated by “star A” in the search information is “star”, and a plurality of search dimensions associated with the attribute of “star” may be predetermined and used as the search dimensions under the search information, and the corresponding search intentions may be considered to represent that the user has an interest in all aspects of the search dimensions of the search object. The plurality of search dimensions associated with the attribute of “star” may specifically include the above-mentioned encyclopedia information, identity information in the team to which the star belongs, works, and may also include endorsed advertisement products, and so on.

For the above S102, after receiving the search information, the plurality of first videos corresponding to the search information and the video preview information corresponding to each of the first videos may be displayed on the search result page first, that is, the search results under the search information are displayed to the user on the search result page.

When determining the plurality of first videos to be displayed, the first videos for displaying may be determined from a plurality of videos, associated with the search information according to the search intentions of the plurality of search dimensions determined in the above steps.

For example, for the above search information “the work of star A”, five videos are obtained by using the search information, including one music video corresponding to the search dimension of song work, three variety show segments belonging to the same variety show corresponding to the search dimension of variety show work, one film and television segment excerpt corresponding to the search dimension of film and television work, and one clothing display video corresponding to the search dimension of clothing design work. These videos include videos corresponding to different search dimensions under the search information, and in order to satisfy the search intentions of the user in the search dimensions of work during searching, the videos in these different search dimensions may be all displayed.

In a possible case, since the number of videos that can be carried in one screen on the search result page is limited, for example, only four videos can be carried and displayed in one screen, in order to ensure that the videos directly displayed on the search result page can correspond to richer search dimensions, for the above example where there are three variety show segments belonging to the same variety show, only one of them may be selected to be displayed on the search result page, and the video in each search dimension is preferably displayed first. In this way, when the user performs the search through the search information and the screen jumps to the search result page to display the search results, the user can first know the video search results in a plurality of different search dimensions, and avoid first displaying a plurality of videos belonging to the same search dimension and arranged in front, so that the user may consider that there are fewer search dimensions corresponding to the currently available videos without turning pages for viewing, and thus may not choose to continue viewing the videos, resulting in a waste of display resources. At the same time, more videos in more search dimensions may be displayed without the user's page turning operation, which actually provides the user with richer search results.

In order to prominently display to the user that the plurality of first videos displayed on the search result page each have their respective search dimensions under the search information, in the embodiments of the present disclosure, the video preview information corresponding to the first videos is displayed at the same time when the first video is displayed. The video preview information described here is specifically used to represent the search dimensions corresponding to the first videos. The video preview information may specifically include one video frame image selected from the videos, or may include identification information displayed in a form of text description, labels, etc.

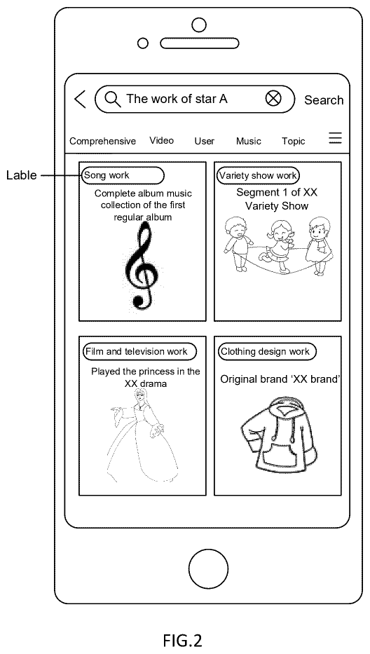

Exemplarily, referring to FIG. 2, it shows a schematic diagram of displaying search results on a search result page according to an embodiment of the present disclosure. When displaying the first videos, an embodiment of the present disclosure shows a display method in which the first videos are arranged and displayed in multi-column display mode. In a specific implementation, a single column or three columns or other multi-column display modes may also be selected for displaying according to the selection of the user or the needs of the platform to display information. “The work of star A” displayed in the search box is the search information in this example, and the four first videos displayed on the search result page correspond to the search intentions in the search dimensions corresponding to the above-mentioned song work, variety show work, film and television work, and clothing design work. In order to facilitate prompting the user of the search dimension associated with each first video, in this example, the search dimension corresponding to each first video is displayed in a form of a label containing text, which can be specifically seen in the upper left label of the displayed first video.

Under the example diagram of FIG. 2, the user can select the first video in the search dimension of interest from the plurality of first videos for viewing through the labels corresponding to each displayed first video (where the text displayed in the first video is the inherent text in the video, such as the title that continuously appears in the video). For example, when the user performs the search, the user actually wants to search for the variety show work of star A, and then the user can view the first video labeled with “variety show work”. Alternatively, after viewing the labels in the search dimensions corresponding to the first videos, the user can select a search dimension of interest from the existing labels and continue viewing. For example, after seeing the four labels shown in FIG. 2, the user is more interested in the clothing design work, and thus can view the first video labeled with the label corresponding to the clothing design work.

Therefore, the labeling of the search dimension of the first video has a prompting effect, and can actually inform the user in advance which search dimension the content of the first video belongs to, so that the user can select the first video in the search dimension that the user wants to obtain from the plurality of displayed first videos corresponding to different search dimensions without viewing the videos one by one. In addition, options can also be provided for the user. For example, the search intention expressed by the user in the search information is not highly targeted, such as the search for “star A” or “the work of star A” as described above. Under the search information, the search intentions in a plurality of search dimensions may actually be indicated. In the way of labeling the search dimension in the first video, a plurality of options can be provided for the user, so that the user can easily select the search dimension of interest from the plurality of options provided and view the first video in the search dimension.

In a specific implementation, in order to enable the first video displayed on the search result page to have more information that can be obtained to facilitate the selection of the user, on the basis of the relatively simple label corresponding to the search dimension shown in FIG. 2, the video preview information corresponding to the first video may be determined specifically by: determining description information related to each of the search dimensions from the first video; and integrating each of the description information determined from the first video to obtain the video preview information corresponding to the first video.

Here, the description information related to the search dimension may include the label described in the above example, and may specifically include introduction information related to the search dimensions that can be obtained from the first videos. The description information may be information obtained from the first video through speech recognition and text recognition, or may be information included in the user name, video title, video introduction, etc.

In a specific implementation, when determining the description information related to the search dimensions from the first videos, the description information related to each of the search dimensions may be determined specifically by: determining text information associated with the first videos, where the text information includes at least one of: introduction information of the first videos or text information identified from the first videos; performing semantic segmentation on the text information to obtain a plurality of candidate keywords; and determining, from the plurality of candidate keywords, at least one candidate keyword, corresponding semantic information of which matches the search dimension, as the description information related to the search dimension.

In a possible case, when displaying the first video, the basic information of the video such as the user name, video title, and video introduction and so on corresponding to the user who releases the video is usually displayed, that is, the introduction information of the first video as described above. If there is description information related to the search dimension in the information, for example, in the case where the first video includes the variety show segment in the above example, the video introduction includes “star A made an appearance in the XX variety show broadcast on X day”, where “XX variety show” is the description information related to the search dimension “variety show work”, and then it may be prominently displayed and emphasized by means of bolding, highlighting, etc., as a prompt to the user. The user name or video title may also be processed in a similar way. For example, for the video of the above variety show segment, the user who released the video is a variety show production group, and its user name is “XX variety show”, and then the user name may also be prominently displayed.

In addition, the identified text information can also be obtained from the first video through speech recognition, text recognition, and other means. In order to display the text information as the video preview information, the video frame to which the text information belongs may be selected as the video cover for displaying and displayed on the search result page first, and the extracted text information may be displayed as the subtitle on the video cover. Similar to the above example, the description information related to the search dimension may be prominently displayed. For example, in the case where the first video includes the variety show work, a video frame image of the opening remarks in the segment may be used as the video cover, and “XX variety show” in the text information “welcome star A to be a guest on XX variety show today” identified corresponding to the video frame may be prominently displayed.

Here, the selection of words selected from the text information as the description information, on the one hand, is based on the needs of users: the users are more inclined to obtain effective information by viewing a brief description when browsing information. On the other hand, it is also due to the limitation of computing power and the requirement of search response time in actual operation. Because the video preview information should be displayed to users as soon as possible, a more efficient way to determine the description information should be selected. Therefore, in the embodiments of the present disclosure, semantic segmentation is performed on the identified text information to obtain a plurality of candidate keywords. For example, for the text information “welcome star A to be a guest on XX variety show today” in the above example, candidate keywords such as “today”, “welcome”, “star A”, and “XX variety show” are obtained after semantic segmentation, and then the matching “XX variety show” is directly selected from the candidate keywords as the description information according to the search dimension “variety show work”. In another possible way, if the candidate keywords that can be used as the description information cannot be obtained from the identified text information by means of semantic segmentation, the description information may also be obtained by analyzing and integrating the text information. The specific way may be determined according to the actual situation, and the implementation is not limited here.

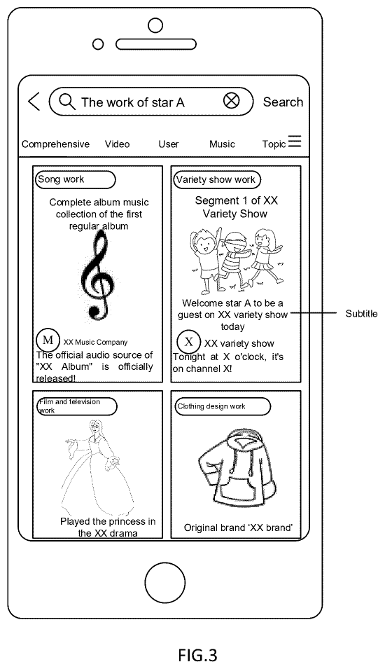

In order to assist in explaining the above example, referring to FIG. 3, it shows an example diagram of displaying video preview information according to an embodiment of the present disclosure. In this example, the first two first videos shown in FIG. 2 are taken as an example for illustration. In the first video displayed with the label “song work”, the user name and user portrait corresponding to the user who releases the video are displayed in the video preview information, and in addition, the video introduction of the first video “the official soundtrack of XX album is officially released!” is also displayed. After performing semantic segmentation on the text information corresponding to the user name and the video introduction, it can be determined from the obtained plurality of candidate keywords that the candidate keyword “XX album” is used as the description information, which is displayed in bold and underlined.

For the second first video displayed with the label “variety show work”, the user name “XX variety show” corresponding to the user who releases the video displayed in the video preview information is a keyword that can be identified and matches the search dimension of “variety show work”, and it is displayed in a way of underlining and bolding similar to the above example. In addition, in the first video, the text information “welcome star A to be a guest on XX variety show today” is also determined by means of text recognition, and the description information “XX variety show” is similarly identified from it, so the video frame image to which the text information belongs is displayed as the cover, which will be different from the image in FIG. 2. In addition, the identified text information may be added to the video frame image as a subtitle during displaying, and the description information such as “XX variety show” may be displayed in bold and underlined.

When displaying the plurality of first videos, the order of display also needs to be considered. In the case where there are a plurality of first videos that can be displayed, in addition to following the rules that the first video whose release time is closer to the current time is preferentially displayed during displaying and the first video officially released is preferentially displayed, because more attention is paid to displaying videos in more diverse search dimensions when displaying the first videos to users, in the case where there are first videos that can cover a plurality of search dimensions, such first videos can be preferentially displayed.

Therefore, in a specific implementation, the display order of arranging and displaying the plurality of first videos may be determined by: determining the dimension number corresponding to at least one search dimension represented by the video preview information of the first videos; and sorting the plurality of first videos with the dimension number determined for each of the first videos, and using a sorting result as the display order of the plurality of first videos.

Exemplarily, for the first video labeled “variety show work” in the above example, which specifically includes the personal song work sung by star A in the variety show, for the first video, in addition to the variety show work, the corresponding search dimensions also includes “song work”, and thus two labels may be displayed together when displaying the labels. In addition, because the first video corresponds to a plurality of search dimensions, it is more likely to satisfy the search needs of the user, and thus the first video corresponding to more search dimensions may be selected to be displayed in front.

In this way, the display of the plurality of first videos and the corresponding preview information can be completed.

For the above S103, for the plurality of displayed first videos, the user can also select one video from them for viewing, and the video selected by the user is referred to as a target video in the embodiments of the present disclosure. In a possible case, only the first video may be played to the user, for example, the first video is directly played on the search result page. Alternatively, it is also possible to jump to the full-screen play page to play the first video, and return to the search result page after playing the first video, and wait for the user to select the next first video for playing. Here, the full-screen play page specifically indicates a page that plays the video in a form of full-screen play, that is, a page that only carries one video for playing.

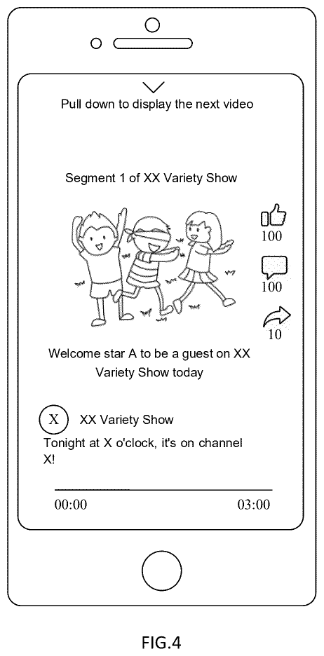

Exemplarily, referring to FIG. 4, it shows a schematic diagram of a full-screen play page according to an embodiment of the present disclosure. In the schematic diagram, a variety show video is taken as an example of the target video for illustration. In response to the trigger to the target video, it can be displayed on the full-screen display page, and the video content, introduction information, etc. of the target video can be displayed, which can be specifically referred to the schematic diagram shown in FIG. 4.

In another possible case, in the case where the user selects the target video, because the target video has an associated search dimension, the selection of the target video by the user may be regarded as the selection of the result that the user wants to obtain under the search intention, and thus the clearer search intention of the user may be known according to the selected target video.

Therefore, when determining the plurality of second videos, the plurality of second videos may be determined according to the search dimension corresponding to the target video. Exemplarily, in the above example, if the selected second video is specifically a variety show segment, it may be determined that the search intention of the user is actually to search for the variety show work, and then the video that is not displayed on the search result page among the three variety show segments belonging to the same variety show described in the above example may be used as the second video.

For the case where the first video is associated with more than one search dimension as described above, if the first video is the target video selected by the user, the videos associated in each of the search dimensions may be used as the second videos.

In this way, according to the selection of the target video by the user from the first videos, the search intention of the user can be inferred, and other videos associated with the search dimension under the search intention are used as the second videos for further display to the user.

For the above S104, the above-mentioned target video selected by the user may be played on the above-mentioned search result page or full-screen display page. After playing the target video, the second videos determined in the above steps may be displayed in response to the switching operation for the target video.

In a specific implementation, the second videos are selected to be played on the full-screen play page.

Because the videos can only be played one by one on the full-screen play page, when playing the second videos, the target order of the second videos during playing may also be specifically determined. In a specific implementation, the target order may be dynamically determined by: obtaining first consumption data obtained with authorization of a user for playing a current second video and second consumption data obtained with authorization of the user for a historical second video played on a full-screen play page before the current second video, in a process of playing the current second video on the full-screen play page; and determining a next video to be played on the full-screen play page from a plurality of candidate videos based on trigger browsing behaviors for each of first videos on the search result page and the first consumption data obtained with authorization of the user as well as the second consumption data obtained with authorization of the user.

Here, the current second video may be the first second video played after switching the target video, or may be the second video being played at any moment in the process of continuously switching videos on the full-screen play page.

For the current second video being played, the corresponding first consumption data obtained with authorization of the user may be obtained. Here, the first consumption data obtained with authorization of the user may specifically include operation data, such as the user's viewing time for the second video, likes and comments, and so on, and these first consumption data obtained with authorization of the user may reflect whether the user is interested in the current second video. For example, if the current second video is a three-minute short video, but the user's viewing time is only 10 seconds, it can be determined with a high probability that the user is not interested in viewing the current second video, so the current second video does not conform to the search intention of the user or the current obtaining intention of the video. However, if the user views the current second video for more than 2 minutes or performs interactive operations such as likes and comments, it can be determined with a high probability that the user is interested in the current second video. And because whether the user is interested in the current second video can be determined through the first consumption data obtained with authorization of the user, videos related to the aspects that the user is interested in may be further pushed to the user, for example, a video containing content of interest is pushed, that is, the target order of the second videos is determined.

For the historical second video played on the full-screen play page before the current second video, in a possible case, if the current second video is the first second video played after switching the target video, after the search time corresponding to the current search information, there is no other second video played before the current second video. The historical second video that can be determined here may be, for example, the historical play video of the user on the platform, and the corresponding second consumption data obtained with authorization of the user is similar to the first consumption data obtained with authorization of the user, but the viewing needs of the user for the video style and the like may be determined by using the second consumption data obtained with authorization of the user, for example, the user wants to view a commentary video or a video segment of the original video under the current viewing needs, and the second video that continues to be played is determined by using these features, that is, the target order of the second videos is determined.

In addition, in addition to determining the needs of the user for viewing the video content through the consumption data of the user during viewing the second video on the full-screen play page, the trigger browsing behaviors for each of the first videos on the search result page may also be used to determine the obtaining needs of the user for the content. In a possible case, the user may select and view different first videos on the search result page, and the behavior of selecting and viewing is the browsing trigger behavior for each of the first videos described in the embodiments of the present disclosure. Here, the browsing trigger behavior being similar to the above viewing time, in the embodiments of the present disclosure, whether the user is really interested in the triggered first video will be determined according to the information such as the viewing time of the user for the first video and the interactive behavior indicated by the browsing trigger behavior, so as to infer the content that the user is really interested in, and push the video containing the content that the user is more interested in when pushing the second video subsequently.

In a specific implementation, when determining the next video to be played on the full-screen play page from the candidate videos by using the trigger browsing behaviors for each of the first videos determined above, the first consumption data obtained with authorization of the user and the second consumption data obtained with authorization of the user, the next video to be played on the full-screen play page from the candidate videos may be determined specifically by: determining a target search dimension from a plurality of search dimensions corresponding to the first videos based on the trigger browsing behaviors; determining first video features corresponding to each of the second videos played on the full-screen play page based on the first consumption data obtained with authorization of the user and the second consumption data obtained with authorization of the user; and determining the next video to be played on the full-screen play page from the plurality of candidate videos based on the first video features and second video features indicated by the target search dimension.

Exemplarily, if the user selects the first video under the variety show work on the full-screen play page and views it relatively completely, “variety show work” may be used as the target search dimension. Alternatively, if the user selects two first videos under the variety show work and the film and television work respectively for viewing, but quits the viewing after only viewing the first video under the film and television work for a few seconds, although the search dimensions corresponding to the selected first videos include the variety show work and the film and television work, the determined target search dimension only includes the search dimension corresponding to the variety show work.

According to the first consumption data obtained with authorization of the user and the second consumption data obtained with authorization of the user, the first video features corresponding to each of the second videos played on the full-screen play page may be determined. The first video feature here may specifically include a video content feature, a video style feature, and so on. Taking the first consumption data obtained with authorization of the user as an example, the current second video specifically indicated by the first consumption data obtained with authorization of the user may specifically determine the content feature and the style feature. First, the content feature is described. Exemplarily, if the current second video is mainly an interview segment of artist A's colleague in a variety show, the content feature may be determined as an interview feature, for example. Alternatively, if the current second video is mainly a daily life photography record of artist A in a variety show, the content feature may be determined as a life record feature, for example.

Next, the video style feature is described. The video style feature may specifically include a style feature of video content, or may also include a style feature related to a video attribute. For example, the video of the commentary type or the video of the original video segment type described in the above embodiments may be used as the style feature of the video content, while the features of being released by an official account, with high likes and high number of comments may be used as the style feature related to the video attribute.

In this way, for the selected target search dimension, the first consumption data obtained with authorization of the user and the second consumption data obtained with authorization of the user, the first video features and the second video features corresponding to each other whether in terms of the content or the style of the video, can be correspondingly obtained.

In the embodiments of the present disclosure, the next video to be played on the full-screen play page may be determined from the plurality of candidate videos by using the first video features and the second video features. The candidate videos may be determined, for example, by: obtaining videos associated with the first video features corresponding to the search information and/or the current second video played on the full-screen play page, as the plurality of candidate videos.

Here, when determining the candidate videos, considering that the information should be displayed according to the search intention of the user in the search scenarios, and considering that the second video related to the recently played video is pushed to the user to satisfy the user's needs for further understanding of the current video content, when determining the candidate videos, the videos associated with the search information and/or the first video features corresponding to the current second video are used as the plurality of candidate videos.

Exemplarily, if the search information is “the work of artist A”, and the current second video is the daily life photography record of artist A in the variety show released by XX variety show, the associated videos are, for example, other life record videos of artist A in the variety show released by XX variety show. In terms of content, it is in line with the dimension of “variety show work” under “work” in the search information, and in terms of features, it is in line with the life record feature and the feature of the official account.

In a possible case, candidate videos that may be determined may comprise several, therefore, when determining the next video to be played on the full-screen play page from the plurality of candidate videos based on the first video features and the second video features indicated by the target search dimension, the next video to be played may be determined by: sorting the plurality of candidate videos based on the correlations between the video features corresponding to each of the candidate videos and the first video features and/or the second video features; and selecting the next video to be played on the full-screen play page from the plurality of candidate videos based on the sorting result of the plurality of candidate videos.

Specifically, since the video features specifically include the content feature, the style feature, and so on, the correlation may also be determined according to the features in these two aspects when determining the correlation. Because the first video features and the second video features may be determined according to the user's prior browsing behavior, the first video features and the second video features may actually reflect the obtaining needs of the user for the videos. On this basis, the video with higher correlation is the video of interest provided to the user, and is displayed in a relatively front position during sorting for the convenience of the user to select. In this way, when displaying the candidate videos, the candidate videos may be displayed according to the sorting result.

In this way, the next video to be played on the full-screen play page is determined.

In the process of the user continuously switching the displayed videos on the full-screen play page, both the first consumption data obtained with authorization of the user for playing the current second video and the second consumption data obtained with authorization of the user for the historical second video played on the full-screen play page before the current second video are constantly changing with the process of switching and displaying the videos, so the process of determining the target order is a dynamic process. In terms of displaying effect, in the process of the user continuously consuming videos on the full-screen play page, since the video features of the effectively consumed videos can be gradually analyzed, the videos that continue to be displayed to the user will be more in line with the viewing needs of the user for videos.

Those skilled in the art can understand that in the above method of the specific implementation, the writing sequence of each step does not mean a strict execution sequence and does not constitute any limitation to the implementation process, and the specific execution sequence of each step should be determined by its function and possible internal logic.

Based on the same inventive concept, the embodiments of the present disclosure further provide a video display apparatus corresponding to the video display method. Since the principle of the apparatus in the embodiments of the present disclosure to solve the problem is similar to the video display method described above in the embodiments of the present disclosure, the implementation of the apparatus may refer to the implementation of the method, and the repetition will not be repeated.

Referring to FIG. 5, it shows a schematic diagram of a video display apparatus according to an embodiment of the present disclosure. The apparatus includes: a receiving module 51, a displaying module 52, a determining module 53, and a playing module 54, where:
the receiving module 51 is configured to receive search information, where the search information includes search intentions of a plurality of search dimensions;
the displaying module 52 is configured to display a plurality of first videos corresponding to the search information and video preview information corresponding to each of the first videos on a search result page, where the plurality of first videos match the search intentions of the search dimensions, and the video preview information of the first video is used to represent a search dimension corresponding to the first video;
the determining module 53 is configured to determine a plurality of second videos in response to a trigger operation for a target video in the plurality of first videos, where the second videos are determined based on a search dimension corresponding to the target video; and
the playing module 54 is configured to play the target video and in response to a switching operation for the target video, play the second videos in a target order.

In an optional implementation, the video display apparatus further includes a processing module 55, and the target order is dynamically determined by the processing module 55 by: obtaining first consumption data obtained with authorization of a user for playing a current second video and second consumption data obtained with authorization of the user for a historical second video played on a full-screen play page before the current second video, in a process of playing the current second video on the full-screen play page; and determining a next video to be played on the full-screen play page from a plurality of candidate videos based on trigger browsing behaviors for each of first videos on the search result page and the first consumption data obtained with authorization of the user as well as the second consumption data obtained with authorization of the user.

In an optional implementation, when determining the next video to be played on the full-screen play page from the plurality of candidate videos based on the trigger browsing behaviors for each of the first videos on the search result page and the first consumption data obtained with authorization of the user as well as the second consumption data obtained with authorization of the user, the processing module 55 is configured to: determine a target search dimension from a plurality of search dimensions corresponding to the first videos based on the trigger browsing behaviors; determine first video features corresponding to each of the second videos played on the full-screen play page based on the first consumption data obtained with authorization of the user and the second consumption data obtained with authorization of the user; and determine the next video to be played on the full-screen play page from the plurality of candidate videos based on the first video features and second video features indicated by the target search dimension.

In an optional implementation, the processing module 55 determines the plurality of candidate videos by: obtaining videos, associated with the search information and/or first video features corresponding to the current second video played on the full-screen play page, as the plurality of candidate videos.

In an optional implementation, when determining the next video to be played on the full-screen play page from the plurality of candidate videos based on the first video features and the second video features indicated by the target search dimension, the processing module 55 is configured to: sort the plurality of candidate videos based on the correlations between the video features corresponding to each of the candidate videos and the first video features and/or the second video features; and select the next video to be played on the full-screen play page from the plurality of candidate videos based on the sorting result of the plurality of candidate videos.

In an optional implementation, when displaying the plurality of first videos on the search result page, the displaying module 52 is configured to: arrange and display each of the first videos in multi-column display mode on the search result page.

In an optional implementation, the video preview information corresponding to the first video is determined by: determining description information related to each of the search dimensions from the first videos; and integrating each of the description information determined from the first videos to obtain the video preview information corresponding to the first videos.

In an optional implementation, the description information related to each of the search dimensions is determined from the first videos by: determining text information associated with the first videos, where the text information includes at least one of: introduction information of the first video or text information identified from the first videos; performing semantic segmentation on the text information to obtain a plurality of candidate keywords; and determining, from the plurality of candidate keywords, at least one candidate keyword, corresponding semantic information of which matches the search dimension, as the description information related to the search dimension.

In an optional implementation, the display order of the plurality of first videos is determined by: determining the dimension number of at least one search dimension represented by the video preview information of each of the first videos; and sorting the plurality of first videos with the dimension number determined for each of the first videos, and using a sorting result as the display order of the plurality of first videos.

For the description of the processing flow of each module in the apparatus and the interaction flow between each module, reference may be made to the related description in the above method embodiments, which will not be described in detail here.

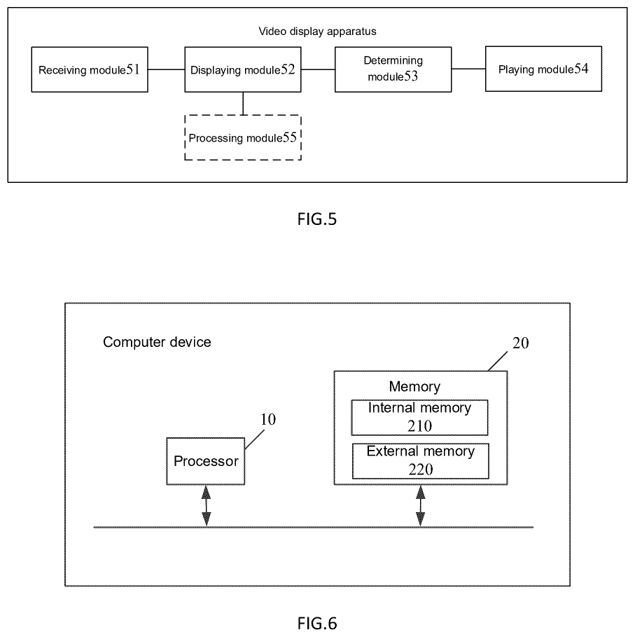

Embodiments of the present disclosure further provide a computer device. As shown in FIG. 6, it is a schematic structural diagram of the computer device according to the embodiments of the present disclosure. The computer device includes:
a processor 10 and a memory 20, where the memory 20 stores machine-readable instructions executable by the processor 10, and the processor 10 is configured to execute the machine-readable instructions stored in the memory 20. When the machine-readable instructions are executed by the processor 10, the processor 10 executes the following steps:
receiving search information, where the search information includes search intentions of a plurality of search dimensions; displaying a plurality of first videos corresponding to the search information and video preview information corresponding to each of the first videos on a search result page, where the plurality of first videos match the search intentions of the search dimensions, and the video preview information of the first videos is used to represent search dimensions corresponding to the first videos; determining a plurality of second videos in response to a trigger operation for a target video from the plurality of first videos, where the second videos are determined based on a search dimension corresponding to the target video; and playing the target video and in response to a switching operation for the target video, playing the second videos in a target order.

The above-mentioned memory 20 includes an internal memory 210 and an external memory 220. The internal memory 210 here is also referred to as an inner-memory, which is used to temporarily store the operation data in the processor 10 and data exchanged with the external memory 220 such as a hard disk. The processor 10 exchanges data with the external memory 220 through the internal memory 210.

For the specific execution process of the above instructions, reference may be made to the steps of the video display method described in the embodiments of the present disclosure, which will not be repeated here.

An embodiment of the present disclosure further provides a computer-readable storage medium, where a computer program is stored on the computer-readable storage medium, and when the computer program is run by a processor, the steps of the video display method described in the above method embodiments are executed. The storage medium may be a volatile or non-volatile computer-readable storage medium.

An embodiment of the present disclosure further provides a computer program product, where the computer program product carries program codes, and instructions included in the program codes may be used to execute the steps of the video display method described in the above method embodiments, which can be specifically referred to the above method embodiments and will not be repeated here.

The above computer program product may be implemented in hardware, software, or a combination thereof. In an optional embodiment, the computer program product is embodied as a computer storage medium. In another optional embodiment, the computer program product is embodied as a software product, such as a software development kit (SDK), etc.

It will be clear for those skilled in the art that, for the convenience and simplicity of description, the specific working process of the above-described system and apparatus may refer to the corresponding process in the foregoing method embodiments, which will not be repeated here. In the several embodiments according to the present disclosure, it should be understood that the disclosed system, apparatus, and method may be implemented in other ways. The apparatus embodiments described above are only illustrative. For example, the division of the units is only a logical function division, and there may be other division ways in actual implementation. For another example, multiple units or components may be combined or integrated into another system, or some features may be ignored or not executed. In addition, the mutual coupling or direct coupling or communication connection shown or discussed may be through some communication interfaces, and the indirect coupling or communication connection of the apparatus or unit may be in electrical, mechanical or other forms.

The unit described as a separate component may or may not be physically separated, and the component displayed as a unit may or may not be a physical unit, that is, it may be located at one place, or may be distributed to multiple network units. Part or all of the units may be selected according to actual needs to achieve the objectives of the solutions of the embodiments.

In addition, the functional units in each embodiment of the present disclosure may be integrated into one processing unit, or each unit may exist alone physically, or two or more units may be integrated into one unit.

If the functions are implemented in the form of software functional units and sold or used as independent products, they may be stored in a non-volatile computer-readable storage medium executable by a processor. Based on such understanding, the technical solutions of the embodiments of the present disclosure may be embodied in the form of a software product, which is stored in a storage medium and includes several instructions for causing a computer device (which may be a personal computer, a server, or a network device, etc.) to execute all or part of the steps of the methods described in the embodiments of the present disclosure. The aforementioned storage medium includes various media that can store program codes, such as a USB flash drive, a mobile hard disk, a read-only memory (Read-Only Memory, ROM), a random-access memory (Random Access Memory, RAM), a magnetic disk or an optical disc, etc.

Finally, it should be noted that the above embodiments are only specific implementations of the present disclosure, which are used to illustrate the technical solutions of the present disclosure, without any limitation. The protection scope of the present disclosure is not limited thereto. Although the present disclosure has been described in detail with reference to the foregoing embodiments, those of ordinary skilled in the art should understand that any person skilled in the art can still modify the technical solutions described in the foregoing embodiments or can easily conceive changes, or make equivalent replacements to some technical features thereof within the technical scope disclosed in the present disclosure. These modifications, changes or replacements do not make the essence of the corresponding technical solutions deviate from the spirit and scope of the technical solutions of the embodiments of the present disclosure, and should be included in the protection scope of the present disclosure. Therefore, the protection scope of the present disclosure should be based on the protection scope of the claims.

1. A video display method, comprising:
receiving search information, wherein the search information comprises search intentions of a plurality of search dimensions;
displaying a plurality of first videos corresponding to the search information and video preview information corresponding to each of the first videos on a search result page, wherein the plurality of first videos match the search intentions of the search dimensions, and the video preview information of the first videos is used for representing the search dimensions corresponding to the first videos;
determining a plurality of second videos in response to a trigger operation for a target video among the plurality of first videos, wherein the second videos are determined based on a search dimension corresponding to the target video; and
playing the target video, and in response to a switching operation for the target video, playing the second videos in a target order.

2. The video display method of claim 1, wherein the target order is dynamically determined by:
obtaining first consumption data obtained with authorization of a user for playing a current second video and obtaining second consumption data obtained with authorization of the user for a historical second video played on a full-screen play page before the current second video, in a process of playing the current second video on the full-screen play page; and
determining a next video to be played on the full-screen play page from a plurality of candidate videos based on trigger browsing behaviors for each of the first videos on the search result page and the first consumption data obtained with authorization of the user as well as the second consumption data obtained with authorization of the user.

3. The video display method of claim 2, wherein the determining the next video to be played on the full-screen play page from the plurality of candidate videos based on the trigger browsing behaviors for each of first videos on the search result page and the first consumption data obtained with authorization of the user as well as the second consumption data obtained with authorization of the user, comprises:
determining a target search dimension from a plurality of search dimensions corresponding to the first videos based on the trigger browsing behaviors; and determining first video features corresponding to each of the second videos played on the full-screen play page based on the first consumption data obtained with authorization of the user and the second consumption data obtained with authorization of the user; and
determining the next video to be played on the full-screen play page from the plurality of candidate videos based on the first video features and second video features, the second video features being indicated by the target search dimension.

4. The video display method of claim 3, wherein the plurality of candidate videos are determined by:
obtaining videos, associated with at least one selected from the group consisting of the search information and the first video features, as the plurality of candidate videos, wherein the first video features correspond to the current second video played on the full-screen play page.

5. The video display method of claim 3, wherein the determining the next video to be played on the full-screen play page from the plurality of candidate videos based on the first video features and the second video features, the second video features being indicated by the target search dimension, comprises:
sorting the plurality of candidate videos based on correlations between video features corresponding to each of the candidate videos and at least one selected from the group consisting of the first video features and the second video features; and
selecting the next video to be played on the full-screen play page from the plurality of candidate videos based on a sorting result of the plurality of candidate videos.

6. The video display method of claim 1, wherein the displaying the plurality of first videos on the search result page, comprises:
arranging and displaying each of the first videos in multi-column display mode on the search result page.

7. The video display method of claim 1, wherein the video preview information corresponding to the first videos is determined by:
determining description information related to each of the search dimensions from the first videos; and
integrating each of the description information determined from the first videos to obtain the video preview information corresponding to the first videos.

8. The video display method of claim 7, wherein the description information related to each of the search dimensions is determined from the first videos by:
determining text information associated with the first videos, wherein the text information comprises at least one of: introduction information of the first videos and text information identified from the first videos;
performing semantic segmentation on the text information to obtain a plurality of candidate keywords; and
determining, from the plurality of candidate keywords, at least one candidate keyword, corresponding semantic information of which matches the search dimensions, as description information related to the search dimensions.

9. The video display method of claim 1, wherein the display order of the plurality of first videos is determined by:
determining a dimension number of at least one search dimension represented by the video preview information of each of the first videos; and
sorting the plurality of first videos with the dimension number determined for each of the first videos, and using a sorting result as the display order of the plurality of first videos.

10. (canceled)

11. A computer device, comprising
at least one processor and a memory, configured to store machine-readable instructions executable by the processor,
wherein the processor is configured to execute the machine-readable instructions stored in the memory, and when the machine-readable instructions are executed by the processor, the processor executes a video display method,
wherein the video display method comprises:
receiving search information, wherein the search information comprises search intentions of a plurality of search dimensions;
displaying a plurality of first videos corresponding to the search information and video preview information corresponding to each of the first videos on a search result page, wherein the plurality of first videos match the search intentions of the search dimensions, and the video preview information of the first videos is used for representing the search dimensions corresponding to the first videos;
determining a plurality of second videos in response to a trigger operation for a target video among the plurality of first videos, wherein the second videos are determined based on a search dimension corresponding to the target video; and
playing the target video, and in response to a switching operation for the target video, playing the second videos in a target order.

12. A non-transitory computer-readable storage medium, wherein a computer program is stored on the computer-readable storage medium, and when the computer program is run by a computer device, the computer device executes a video display method,
wherein the video display method comprises:
receiving search information, wherein the search information comprises search intentions of a plurality of search dimensions;
displaying a plurality of first videos corresponding to the search information and video preview information corresponding to each of the first videos on a search result page, wherein the plurality of first videos match the search intentions of the search dimensions, and the video preview information of the first videos is used for representing the search dimensions corresponding to the first videos;
determining a plurality of second videos in response to a trigger operation for a target video among the plurality of first videos, wherein the second videos are determined based on a search dimension corresponding to the target video; and
playing the target video, and in response to a switching operation for the target video, playing the second videos in a target order.

13. The video display method of claim 4, wherein the determining the next video to be played on the full-screen play page from the plurality of candidate videos based on the first video features and the second video features, the second video features being indicated by the target search dimension, comprises:
sorting the plurality of candidate videos based on correlations between video features corresponding to each of the candidate videos and at least one selected from the group consisting of the first video features and the second video features; and
selecting the next video to be played on the full-screen play page from the plurality of candidate videos based on a sorting result of the plurality of candidate videos.

14. The computer device of claim 11, wherein the target order is dynamically determined by:
obtaining first consumption data obtained with authorization of a user for playing a current second video and obtaining second consumption data obtained with authorization of the user for a historical second video played on a full-screen play page before the current second video, in a process of playing the current second video on the full-screen play page; and
determining a next video to be played on the full-screen play page from a plurality of candidate videos based on trigger browsing behaviors for each of the first videos on the search result page and the first consumption data obtained with authorization of the user as well as the second consumption data obtained with authorization of the user.

15. The computer device of claim 14, wherein the determining the next video to be played on the full-screen play page from the plurality of candidate videos based on the trigger browsing behaviors for each of first videos on the search result page and the first consumption data obtained with authorization of the user as well as the second consumption data obtained with authorization of the user, comprises:
determining a target search dimension from a plurality of search dimensions corresponding to the first videos based on the trigger browsing behaviors; and determining first video features corresponding to each of the second videos played on the full-screen play page based on the first consumption data obtained with authorization of the user and the second consumption data obtained with authorization of the user; and
determining the next video to be played on the full-screen play page from the plurality of candidate videos based on the first video features and second video features, the second video features being indicated by the target search dimension.

16. The computer device of claim 15, wherein the plurality of candidate videos are determined by:
obtaining videos, associated with at least one selected from the group consisting of the search information and the first video features, as the plurality of candidate videos, wherein the first video features correspond to the current second video played on the full-screen play page.

17. The computer device of claim 15, wherein the determining the next video to be played on the full-screen play page from the plurality of candidate videos based on the first video features and the second video features, the second video features being indicated by the target search dimension, comprises:
sorting the plurality of candidate videos based on correlations between video features corresponding to each of the candidate videos and at least one selected from the group consisting of the first video features and the second video features; and
selecting the next video to be played on the full-screen play page from the plurality of candidate videos based on a sorting result of the plurality of candidate videos.

18. The computer device of claim 11, wherein the displaying the plurality of first videos on the search result page, comprises: arranging and displaying each of the first videos in multi-column display mode on the search result page.

19. The computer device of claim 11, wherein the video preview information corresponding to the first videos is determined by:
determining description information related to each of the search dimensions from the first videos; and
integrating each of the description information determined from the first videos to obtain the video preview information corresponding to the first videos.

20. The computer device of claim 19, wherein the description information related to each of the search dimensions is determined from the first videos by:
determining text information associated with the first videos, wherein the text information comprises at least one of: introduction information of the first videos and text information identified from the first videos;
performing semantic segmentation on the text information to obtain a plurality of candidate keywords; and
determining, from the plurality of candidate keywords, at least one candidate keyword, corresponding semantic information of which matches the search dimensions, as description information related to the search dimensions.

21. The computer device of claim 11, wherein the display order of the plurality of first videos is determined by:
determining a dimension number of at least one search dimension represented by the video preview information of each of the first videos; and
sorting the plurality of first videos with the dimension number determined for each of the first videos, and using a sorting result as the display order of the plurality of first videos.
